(19) United States
(12) Patent Application Publication
(10) Pub. No.: US 2025/0139885 A1
(43) Pub. Date: May 1, 2025

(54) VIRTUAL PROP DISPLAY METHOD AND APPARATUS

(71) Applicant: Shanghai Hode Information Technology Co., Ltd., Shanghai (CN)

(72) Inventor: Yi ZHANG, Shanghai (CN)

(21) Appl. No.: 18/690,577

(22) PCT Filed: Jun. 21, 2022
(86) PCT No.: PCT/CN2022/100038

§ 371 Date: Mar. 8, 2024

(30) Foreign Application Priority Data
Sep. 10, 2021 (CN) 202111062754.6

(51) Int. Cl. G06T 17/00; G06T 7/73

(52) U.S. Cl. CPC G06T 17/00; G06T 7/73; G06T 2207/20044

(57) ABSTRACT

This application provides a virtual prop display method and apparatus. The virtual prop display method includes: receiving a to-be-processed video stream, and recognizing a target video frame in the to-be-processed video stream; parsing the target video frame and generating target skeleton point information; when the target skeleton point information conforms to preset pose information, obtaining virtual prop information of a virtual prop corresponding to the preset pose information; and displaying the virtual prop in the target video frame based on the target skeleton point information and the virtual prop information.

This application claims priority to Chinese Patent Application No. 202111062754.6, filed with the China National Intellectual Property Administration on Sep. 10, 2021, and entitled “VIRTUAL PROP DISPLAY METHOD AND APPARATUS”, which is incorporated herein by reference in its entirety.

### TECHNICAL FIELD

This application relates to the field of artificial intelligence technologies, and in particular, to a virtual prop display method. This application also relates to a virtual prop display apparatus, a computing device, a computer-readable storage medium, and a computer program.

### BACKGROUND

With continuous development of computer technologies, more applications display a virtual prop with reference to an action or an expression of an entity. For example, a virtual fitting function enables users to see how clothes look on them without the need for actual dressing, providing a convenient way for the users to try on clothing.

However, a common device cannot deeply analyze the entity. In other words, the common device can capture only a two-dimensional picture. Consequently, when a three-dimensional prop is displayed, the prop is unrealistically displayed, and user experience is affected.

Therefore, how to improve accuracy of displaying the virtual prop becomes an urgent technical problem to be resolved by a person skilled in the art.

### SUMMARY

In view of this, embodiments of this application provide a virtual prop display method. This application also relates to a virtual prop display apparatus, a computing device, a computer-readable storage medium, and a computer program, to resolve a problem in the conventional technology that a virtual prop is unrealistically displayed and user experience is poor.

According to a first aspect of the embodiments of this application, a virtual prop display method is provided, including:
receiving a to-be-processed video stream, and recognizing a target video frame in the to-be-processed video stream;
parsing the target video frame, to obtain target skeleton point information;
when the target skeleton point information conforms to preset pose information, obtaining virtual prop information of a virtual prop corresponding to the preset pose information; and
displaying the virtual prop in the target video frame based on the target skeleton point information and the virtual prop information.

According to a second aspect of the embodiments of this application, a virtual prop display apparatus is provided, including:
a recognition means, configured to: receive a to-be-processed video stream, and recognize a target video frame in the to-be-processed video stream;
a parsing means, configured to parse the target video frame, to obtain target skeleton point information;
an obtaining means, configured to: when the target skeleton point information conforms to preset pose information, obtain virtual prop information of a virtual prop corresponding to the preset pose information; and
a display means, configured to display the virtual prop in the target video frame based on the target skeleton point information and the virtual prop information.

According to a third aspect of the embodiments of this application, a computing device is provided, including a memory, a processor, and computer instructions stored in the memory and capable of being run on the processor, where when the processor executes the computer instructions, steps of the virtual prop display method are implemented.

According to a fourth aspect of the embodiments of this application, a computer-readable storage medium is provided. The computer-readable storage medium stores computer instructions. When the computer instructions are executed by a processor, steps of the virtual prop display method are implemented.

According to a fifth aspect of the embodiments of this application, a computer program product is provided. When the computer program product is executed on a computer, the computer is enabled to perform steps of the virtual prop display method.

According to the virtual prop display method provided in this application, the to-be-processed video stream is received, and the target video frame in the to-be-processed video stream is recognized; the target video frame is parsed, to obtain the target skeleton point information; when the target skeleton point information conforms to the preset pose information, the virtual prop information of the virtual prop corresponding to the preset pose information is obtained; and the virtual prop is displayed in the target video frame based on the target skeleton point information and the virtual prop information.

According to an embodiment of this application, whether a pose in a video frame is consistent with a preset pose is determined based on the preset pose information. When the pose in the video frame is consistent with the preset pose, the virtual prop is displayed based on skeleton information in the video frame, to improve accuracy of displaying the virtual prop and the pose, and bring a better visual effect to a user.

### BRIEF DESCRIPTION OF DRAWINGS

FIG. 1 is a flowchart of a virtual prop display method according to an embodiment of this application;

FIG. 2 is a processing flowchart of a virtual prop display method applied to virtual animation role-playing according to an embodiment of this application;

FIG. 3 is a schematic diagram of a preset pose according to an embodiment of this application;

FIG. 4 is a schematic diagram of a structure of a preset pose according to an embodiment of this application;

FIG. 5 is a schematic diagram of a structure of a virtual prop display apparatus according to an embodiment of this application; and

FIG. 6 is a block diagram of a structure of a computing device according to an embodiment of this application.

### DESCRIPTION OF EMBODIMENTS

Many specific details are described in the following descriptions, to facilitate full understanding of this application. However, this application can be implemented in many other manners different from those described herein. A person skilled in the art can make similar promotion without departing from the connotation of this application. Therefore, this application is not limited to specific implementations disclosed below.

Terms used in one or more embodiments of this application are merely used to describe specific embodiments, and are not intended to limit the one or more embodiments of this application. The terms “a” and “the” that are in singular forms and that are used in one or more embodiments and the appended claims of this application are also intended to include plural forms, unless otherwise specified in the context clearly. It should also be understood that, the term “and/or” used in one or more embodiments of this application indicates and includes any or all possible combinations of one or more associated listed props.

It should be understood that although the terms such as “first” and “second” may be used in one or more embodiments of this application to describe various types of information, the information should not be limited to these terms. These terms are merely used to distinguish between information of a same type. For example, without departing from the scope of the one or more embodiments of this application, “first” may also be referred to as “second”, and similarly, “second” may also be referred to as “first”. Depending on the context, for example, the word “if” used herein can be interpreted as “while”, “when”, or “in response to determining”.

Terms used in the one or more embodiments of this application are explained first.

OpenPose: A human pose recognition project is an open source library developed based on a convolutional neural network and supervised learning and by using caffe as a framework. Poses such as a body movement, a facial expression, and a finger movement may be estimated. OpenPose is applicable to a single person and a plurality of persons, and is the first deep learning-based real-time multi-person two-dimensional pose estimation application in the world. Examples based on OpenPose are springing up. A human body pose estimation technology has a wide application prospect in fields such as physical fitness, motion capture, 3D fitting, and public opinion monitoring.

As the two-dimensional culture becomes more popular, more people in the market want to participate in COSPLAY. COSPLAY refers to dressing up as characters from one's favorite novels, animations, or games, using clothing, accessories, props, and makeup. “COS” is an abbreviation of “Costume” in English, and a verb thereof is “COS”, and a person who plays COS is generally referred to as “COSER”. However, such a translation and “Role Playing Game (RPG)” in a game both mean role playing. Therefore, to avoid similarity, more exactly, COS is dressing a costume. COSPLAY is playing an animation role. However, not everyone has such an opportunity due to dependence on a place, clothing, a prop, and makeup. One of application scenarios of a technical means provided in this application is to enable a player to simulate a pose of a role in a game before a lens, and experience a feeling of COSPLAY for one time.

This application provides a virtual prop display method. This application also relates to a virtual prop display apparatus, a computing device, a computer-readable storage medium, and a computer program. The virtual prop display method, the virtual prop display apparatus, the computing device, the computer-readable storage medium, and the computer program are described in detail one by one in the following embodiments.

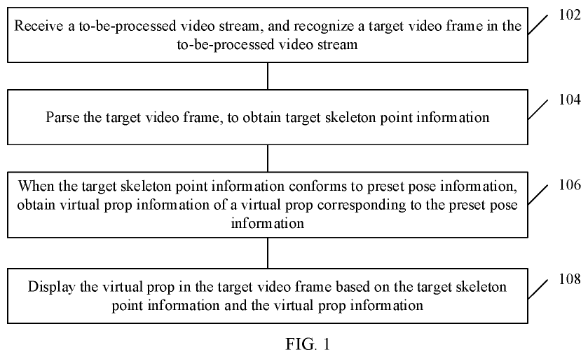

FIG. 1 is a flowchart of a virtual prop display method according to an embodiment of this application. The method specifically includes the following steps.

Step 102: Receive a to-be-processed video stream, and recognize a target video frame in the to-be-processed video stream.

A server receives the to-be-processed video stream, recognizes a target video frame that meets a requirement in the received to-be-processed video stream, and is configured to subsequently display a virtual prop in the target video frame.

The to-be-processed video stream is a video stream captured by using an image capture device. The target video frame is a video frame that includes a specific image in the to-be-processed video stream. For example, the image capture device may be a camera device in a shopping mall. The camera device captures a picture in the shopping mall, and generates the video stream. The target video frame is a video frame that includes a character image and that is recognized in the video stream.

In an actual application, a specific method for recognizing the target video frame in the to-be-processed video stream includes:
determining a preset recognition rule; and
recognizing, as the target video frame based on the preset recognition rule, a video frame that conforms to the preset recognition rule in the to-be-processed video stream.

The preset recognition rule is a rule of recognizing a target video frame that includes an entity in the to-be-processed video stream. For example, the video frame that includes the character image in the to-be-processed video stream is recognized as the target video frame, or a video frame that includes an object image in the to-be-processed video stream is recognized as the target video frame.

Specifically, the to-be-processed video stream is determined, a video frame in the to-be-processed video stream is input into an entity recognition model, and a video frame that includes an entity and that is determined based on the entity recognition model is used as the target video frame. The recognition model may be a character image recognition model, an animal image recognition model, or the like. Alternatively, the target video frame may be determined in the to-be-processed video stream by using another image recognition technology. A specific method for recognizing the target video frame is not limited in this application, provided that a manner can meet a video frame recognition requirement.

In a specific implementation of this application, that the preset recognition rule is a character image recognition rule is used as an example. The to-be-processed video stream is received, and the video frame in the to-be-processed video stream is input into the character image recognition model, so that the video frame that includes the character image in the video frame is determined as the target video frame.

The target video frame is determined in the to-be-processed video stream based on the preset recognition rule, to improve recognition efficiency. Subsequently, only the determined target video frame needs to be processed, to improve virtual prop display efficiency.

Step 104: Parse the target video frame and generate target skeleton point information.

After the target video frame is determined, the target video frame is parsed, to determine all skeleton point information of the entity in the target video frame. Some skeleton point information that meets a requirement is determined from all the skeleton point information, to subsequently determine, based on the skeleton point information, whether a pose of the entity conforms to a preset pose.

In an actual application, a method for parsing the target video frame, to obtain the target skeleton point information includes:
parsing the target video frame, to obtain a skeleton point information set;
determining to-be-processed skeleton point information from the skeleton point information set based on preset pose information; and
converting the to-be-processed skeleton point information, to obtain the target skeleton point information.

The skeleton point information set is a set including location information corresponding to a skeleton point parsed out from the target video frame. For example, skeleton points obtained by parsing a character image video frame include a nose, a neck, a right shoulder, a right elbow, a right wrist, a left shoulder, a left elbow, a left wrist, a center of a crotch, a right hip, a right knee, a right ankle, a left crotch, a left knee, a left ankle, a right eye, a left eye, a right ear, a left ear, a left foot inside, a left foot outside, a left heel, a right foot inside, a right foot outside, a right heel, and two-dimensional coordinates of each skeleton point in the target video frame that are obtained by parsing the character image video frame. The skeleton points and corresponding coordinates form the skeleton point information set. A method for obtaining the skeleton point in the target video frame through parsing includes but is not limited to a technology such as OpenPose. After the skeleton point in the target video frame is determined, a rectangular coordinate system may be established in the target video frame, to determine a coordinate location of each skeleton point in the target video frame.

In addition, the skeleton point obtained through parsing may be used as a binding skeleton point, and is bound to a corresponding virtual prop. The preset pose information is proportion information between vectors including skeleton points corresponding to the preset pose and angle information between the vectors including the skeleton points. The to-be-processed skeleton point information is skeleton point information corresponding to the preset pose information in the skeleton point information set. The target skeleton point information is the skeleton point information obtained by converting the to-be-processed skeleton point. For example, the proportion information included in the preset pose information is that a length proportion of a skeleton from the left wrist to the left elbow to a skeleton from the left elbow to the left shoulder is 1:1, and the angle information is that a value of an included angle between the skeleton from the left wrist to the left elbow to the skeleton from the left elbow to the left shoulder is 15 degrees. The to-be-processed skeleton point information is two-dimensional skeleton point coordinates of the left wrist, the left elbow, and the left shoulder, and the target skeleton point information is three-dimensional coordinates that are obtained by converting two-dimensional coordinates of the left wrist, the left elbow, and the left shoulder.

Specifically, the target video frame is parsed, to obtain all skeleton points in the target video frame, and coordinates of each skeleton point are determined and form the skeleton point information set. The preset pose information is determined, and skeleton point information used for subsequent pose determining in the skeleton point information set is determined as the to-be-processed skeleton point information based on the preset pose information. The two-dimensional to-be-processed skeleton point information is converted into three-dimensional skeleton point information in a preset conversion manner, to obtain the target skeleton point information. For example, the preset conversion manner may be a manner of adding 0 to a z axis, to convert a two-dimensional matrix into a three-dimensional matrix.

In a specific implementation of this application, that the target video frame is a character image video frame is used as an example. The character image video frame is parsed, to obtain a skeleton point information set {left wrist: (2, 2), left elbow: (5, 3), . . . }. Herein, “left wrist: (2, 2)” indicates that coordinates of a left wrist skeleton point of a character in the character image video frame are (2, 2). The preset pose information is that a proportion of a distance between the left wrist skeleton point to a left elbow skeleton point to a distance between the left elbow skeleton point and a left shoulder skeleton point is 1:1, and the value of the included angle between the skeleton from the left wrist to the left elbow and the skeleton from the left elbow to the left shoulder is 15 degrees. It is determined, based on the preset pose information, that the to-be-processed skeleton point information in the skeleton point information set is the left wrist skeleton point, the left elbow skeleton point, and the left shoulder skeleton point. The to-be-processed skeleton point information is converted into the target skeleton point information. To be specific, 0 is added to the two-dimensional to-be-processed skeleton point information as a coordinate of the z axis, to obtain the three-dimensional target skeleton point information.

The video frame is parsed, and the to-be-processed skeleton information is determined in the video frame based on the preset pose information. Subsequently, only the to-be-processed skeleton information is further calculated, to improve processing efficiency. The to-be-processed video frame is converted into the three-dimensional target video frame, to subsequently combine the three-dimensional target video frame and coordinates of a 3D virtual prop model, to realistically display a three-dimensional virtual prop in the video frame.

Step 106: When the target skeleton point information conforms to the preset pose information, obtain virtual prop information of a virtual prop corresponding to the preset pose information.

The virtual prop is a prop displayed in the video frame, for example, a virtual shield or virtual clothing. The virtual prop information is information required for displaying the virtual prop, and includes but is not limited to the virtual prop model information and virtual prop display location information.

In the solution of this application, when it is recognized that the pose of the entity in the video frame is consistent with the preset pose, a virtual prop corresponding to the pose is displayed in the video frame. Therefore, after the target video frame is parsed, to obtain the target skeleton point information, whether the pose of the entity in the video frame is consistent with the preset pose needs to be determined. A specific determining procedure includes:
determining pose proportion information and/or pose angle information in the preset pose information, and determining whether the target skeleton point information conforms to the pose proportion information and/or the pose angle information; and
if the target skeleton point information conforms to the pose proportion information and/or the pose angle information, determining that the target skeleton point information conforms to the preset pose information; or
if the target skeleton point information does not conform to the pose proportion information or the pose angle information, determining that the target skeleton point information does not conform to the preset pose information.

The pose proportion information is a skeleton length proportion determined based on the skeleton point. The pose angle information is an angle value of an included angle between skeletons determined based on the skeleton point.

Specifically, the pose proportion information and/or the pose angle information in the preset pose information are/is determined. The pose proportion information includes a pose proportion range, and the pose angle information includes a pose angle range. Pose proportion information and/or pose angle information in the target skeleton point information are/is determined, whether pose proportion information that is in the target skeleton point information and that is obtained through calculation falls within the pose proportion range is determined, whether the pose angle information that is in the target skeleton point information and that is obtained through calculation falls within the pose angle range is determined, and if the pose proportion information exceeds the pose proportion range or the pose angle information exceeds the pose angle range, it is determined that the pose of the entity in the video frame does not conform to the preset pose.

In a specific implementation of this application, that the preset pose information includes the pose angle information and the pose proportion information is used as an example. In this embodiment, the pose proportion information is that a skeleton length from the left shoulder to the left elbow and a skeleton length from the left elbow to a left hand are 1:1, and a preset floating range is 0.2. The pose angle information is that the included angle between the skeleton from the left shoulder to the left elbow and the skeleton from the left elbow to the left wrist is 15 degrees, and a preset floating range is three degrees. It is learned, through calculation based on the target skeleton point information, that the proportion of the skeleton length from the left shoulder to the left elbow to the skeleton length from the left elbow to the left hand in the target video frame is 0.7:1, and exceeds a preset floating range. A vector value of the skeleton from the left shoulder to the left elbow and a vector value of the skeleton from the left elbow to the left wrist are calculated, and it is learned through calculation that a value of an included angle between the vector values is 14 degrees, and falls within a preset floating range. Because the target skeleton information does not conform to the pose proportion information in the preset pose information, the target skeleton point information does not conform to the preset pose information.

In another specific implementation of this application, that the preset pose information includes the pose proportion information is used as an example. In this embodiment, the pose proportion information is that a skeleton length from the left shoulder to the left elbow and a skeleton length from the left elbow to a left hand are 1:1, and a preset floating range is 0.2. The target skeleton point information is determined. In other words, coordinates of the left shoulder, the left hand, and the left elbow are determined. It is learned, through calculation based on the coordinates, that a proportion of the skeleton length from the left shoulder to the left elbow to the skeleton length from the left elbow to the left hand in the target video frame is 0.9:1, and falls within a preset floating range. It is determined that the target skeleton point information conforms to the preset pose information.

In still another specific implementation of this application, that the preset pose information includes the pose angle information is used as an example. In this embodiment, the pose angle information is that the included angle between the skeleton from the left shoulder to the left elbow and the skeleton from the left elbow to the left wrist is 15 degrees, and a preset floating range is 3 degrees. The target skeleton point information is determined. In other words, coordinates of the left shoulder, the left elbow, and the left wrist are determined. A vector value of the skeleton from the left shoulder to the left elbow and a vector value of the skeleton from the left elbow to the left wrist are calculated based on the coordinates. It is learned, through calculation, that a value of an included angle between the vector values is 14 degrees, and falls within a preset floating range. Therefore, it is determined that the target skeleton point information conforms to the preset pose information.

Whether skeleton information in the video frame conforms to the preset pose information is determined, to display the virtual prop when the skeleton information conforms to the preset pose information, so that accuracy of displaying the virtual prop is ensured. The virtual prop can be seen only after it is determined that a user makes the preset pose, to improve a degree of participation of the user.

In an actual application, the skeleton length is obtained through calculation based on the skeleton point in the target skeleton point information, and the determining whether the target skeleton point information conforms to the pose proportion information and/or the pose angle information includes:
determining target skeleton vectors based on the target skeleton point information;
calculating skeleton proportion information and/or skeleton angle information between the target skeleton vectors; and
determining whether the skeleton proportion information conforms to the pose proportion information, and/or determining whether the skeleton angle information conforms to the pose angle information.

The target skeleton vector is a skeleton length between skeleton points obtained through calculation based on the target skeleton point information. For example, if it is learned that a coordinate value of a left wrist skeleton point A is (x1, y1), and a coordinate value of a left elbow skeleton point B is (x2, y2), a vector v from the skeleton point A to the skeleton point B may be represented by using Formula 1:

$$v = B - A = [ \begin{matrix}{x}_{2} - {x}_{1} \\ {y}_{2} - {y}_{1}\end{matrix} ] \qquad Formula 1$$

The skeleton proportion information is proportion information that is between skeletons in the target video frame and that is obtained through calculation based on the target skeleton point information. The skeleton angle information is angle information of an included angle that is between skeletons in the target video frame and that is obtained through calculation based on the target skeleton point information.

Specifically, the preset pose information includes the pose proportion information, or the pose angle information, or the pose proportion information and pose angle information. After the skeleton proportion information and/or the skeleton angle information are/is obtained through calculation, the skeleton proportion information is compared with the pose proportion information, and the skeleton angle information is compared with the pose angle information, to determine whether the target skeleton point information conforms to the preset pose information.

In an actual application, when it is determined that the target skeleton point information conforms to the preset pose information, a specific manner of obtaining the virtual prop information of the virtual prop corresponding to the preset pose information includes:
determining the virtual prop corresponding to the preset pose information;
obtaining a virtual prop information table; and
determining the virtual prop from the virtual prop information table, and obtaining the virtual prop information corresponding to the virtual prop.

The virtual prop information table is a data table that includes virtual props and the virtual prop information corresponding to the virtual props, or the virtual prop information table is a data table that includes virtual props, corresponding virtual prop information, and preset pose information corresponding to the virtual props. For example, the virtual prop information table includes a virtual prop chicken leg and chicken leg information, or the virtual prop information table includes the preset pose information, a virtual prop chicken leg corresponding to the preset pose information, and chicken leg information corresponding to the virtual prop chicken leg.

In a specific implementation of this application, that the virtual prop is a shield is used as an example. The virtual prop information table is obtained. In this embodiment, the virtual prop corresponding to the preset pose information is a shield. A shield prop is determined in the virtual prop information table, and shield prop information corresponding to the shield prop is obtained.

In an actual application, the target skeleton point information may not conform to the preset pose information. In this case, a specific operation manner of a next step of the solution includes:
if the target skeleton point information does not conform to the preset pose information, continuing to perform the step of recognizing a target video frame in the to-be-processed video stream, and sending a pose error prompt.

Specifically, when the target skeleton point information does not conform to the preset pose information, a new target video frame continues to be determined in the to-be-processed video stream, and a pose of an entity in the new target video frame continues to be determined. In addition, when the target skeleton point information does not conform to the preset pose information, the pose error prompt and pose guidance information may be sent to a client, so that the user can find a correct preset pose more quickly.

In a specific implementation of this application, that the target skeleton point information does not conform to the preset pose information is used as an example. Based on a determining result that the target skeleton point information does not conform to the preset pose information, a pose failure reminder and the pose guidance information are sent to the client, so that the user can find and make a correct pose based on the pose guidance information.

When a pose in the target video frame does not conform to the preset pose, another target video frame in the to-be-processed video stream continues to be recognized, to obtain different poses in the video stream in a timely manner, so that the virtual prop is displayed in a timely manner when the pose conforms to the preset pose. The pose guidance information is sent to the user, so that the user can find a correct pose more quickly, to improve user use experience.

Step 108: Display the virtual prop in the target video frame based on the target skeleton point information and the virtual prop information.

After target skeleton information that conforms to the preset pose information is determined, the virtual prop information is obtained, and the virtual prop corresponding to the virtual prop information is displayed in the target video frame based on the target skeleton point information and the virtual prop information.

In an actual application, a method for displaying the virtual prop in the target video frame based on the target skeleton point information and the virtual prop information includes:
determining virtual prop anchor information of the virtual prop based on a virtual prop anchor of the virtual prop and the target skeleton point information; and
displaying the virtual prop in the target video frame based on the virtual prop information, the virtual prop anchor information, and the target skeleton point information.

The virtual prop anchor is a center point of a virtual prop in the preset pose. The virtual prop anchor information is skeleton point location information and offset information existing when the virtual prop anchor is displayed in the target video frame. The skeleton point location information is a location of the virtual prop anchor in a skeleton corresponding to the preset pose. For example, the skeleton point location information is that the virtual prop anchor is bound to a right hand skeleton point in the skeleton, and the offset information is information about an offset from the skeleton, for example, an offset to a location that is 30% above the right hand skeleton point.

In a specific implementation of this application, that the virtual prop is a hat is used as an example. It is determined that anchor information of a virtual prop hat is a point that is 30% above the skeleton between the left wrist and the left elbow. A hat prop is displayed in the target video frame based on hat prop information, the anchor information of the hat, and the target skeleton point information.

In an actual application, to display the virtual prop effect in the target video frame more realistically, a specific method for calculating the virtual prop anchor information of the virtual prop based on the virtual prop anchor information of the virtual prop and the target skeleton point information includes:

calculating, based on the virtual prop anchor information in the virtual prop information and the target skeleton point information, a virtual prop matrix existing when the virtual prop is displayed in the target video frame.

The virtual prop matrix is coordinates of the virtual prop that exist when the virtual prop is displayed in the target video frame.

In a specific implementation of this application, that a virtual prop is a shield is used as an example. Anchor information of a shield prop is a point that is on the skeleton from the left wrist to the left elbow and that is 5% close to the left wrist. An anchor coordinate value, that is, a shield prop matrix, existing when the shield is displayed in conformity with the preset pose is calculated based on skeleton point coordinates and the anchor information of the shield prop.

An anchor matrix existing when the virtual prop anchor is displayed in the target video frame is calculated based on the preset virtual prop anchor information in the virtual prop information and with reference to current target skeleton information, to determine a display location of the virtual prop in the target video frame, thereby improving a degree of combination of the virtual prop and the pose in the target video frame, and displaying the virtual prop in the video frame more realistically.

In an actual application, before the to-be-processed video stream is received to obtain the video frame, the preset pose information and the virtual prop information of the virtual prop corresponding to the preset pose information need to be preset. A method for specifically generating the preset pose information includes:
determining the pose angle information and/or the pose proportion information; and
generating the preset pose information based on the pose angle information and/or the pose proportion information.

Specifically, the pose proportion information and/or the pose angle information corresponding to the preset pose are/is determined. For example, if the preset pose is lifting the shield, proportion information and angle information existing when the skeleton is at a pose of lifting the shield are determined. After the pose proportion information and/or the pose angle information are/is determined, the pose angle information and/or the pose proportion information form/forms the preset pose information.

In a specific implementation of this application, that the preset pose is lifting a right arm is used as an example. It is determined that the preset proportion information is that a proportion of a corresponding skeleton length from the right wrist to the right elbow to a corresponding skeleton length from the right elbow to the right shoulder is 1:1, and a floating range does not exceed 0.2. It is determined that the preset angle information is that an included angle between a corresponding skeleton from the right wrist to the right elbow and a corresponding skeleton from the right elbow to the right shoulder is 90 degrees, and a floating range does not exceed 3 degrees. The preset proportion information and the preset angle information form the preset pose information

The pose proportion information and the pose angle information are preset, so that a target video frame that conforms to the preset pose is determined in the video frame, and a character pose in the video frame may be determined more accurately by determining a pose based on the preset proportion information, to help realistically display the virtual prop subsequently.

A method for specifically generating the virtual prop information of the virtual prop includes: obtaining virtual prop model information of the virtual prop and the virtual prop anchor of the virtual prop;
defining virtual prop anchor information of the virtual prop anchor between skeleton points based on the preset pose information corresponding to the virtual prop; and
generating the virtual prop information corresponding to the virtual prop based on the virtual prop model information and the virtual prop anchor information.

The virtual prop model information is attribute information of the virtual prop model, for example, model material information and model color information.

Specifically, a pre-created virtual prop model is obtained, and a virtual prop anchor is determined. The anchor is a center point of a model image, and is used to display an offset of the model image. The virtual prop model may be created by using 3dmax, maya, or the like. This is not specifically limited in this application. After a created virtual prop is determined, the virtual prop is bound to the preset pose, that is, specific location information of a preset virtual prop anchor on a skeleton of the preset pose, that is, virtual prop anchor information is determined. The virtual prop information of the virtual prop corresponding to the preset pose information is formed based on the virtual prop model information and the virtual prop anchor information.

The virtual prop information is preset, including binding the virtual prop anchor to a skeleton point, and converting two-dimensional skeleton point information in an obtained image into three-dimensional skeleton point information, so that a three-dimensional virtual prop and a skeleton point in a picture are combined to a higher degree, thereby improving accuracy of subsequently displaying the virtual prop.

According to the virtual prop display method in this application, the to-be-processed video stream is received, and the target video frame in the to-be-processed video stream is recognized; the target video frame is parsed, to obtain the target skeleton point information; when the target skeleton point information conforms to the preset pose information, the virtual prop information of the virtual prop corresponding to the preset pose information is obtained; and the virtual prop is displayed in the target video frame based on the target skeleton point information and the virtual prop information. In an embodiment of this application, whether a pose in a video frame is consistent with a preset pose is determined based on the preset pose information. When the pose in the video frame is consistent with the preset pose, the virtual prop is displayed based on skeleton information in the video frame, to improve accuracy and a real degree of displaying the virtual prop and the pose, and bring a better visual effect to a user.

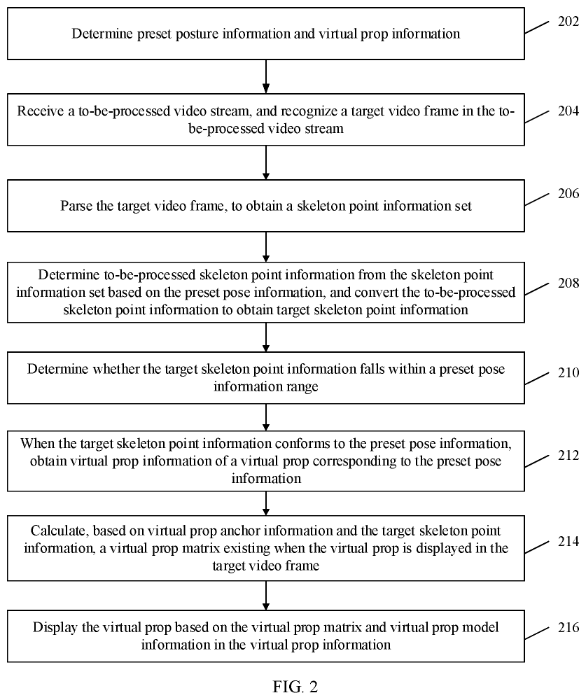

The following further describes, with reference to FIG. 2, the virtual prop display method by using an example in which the virtual prop display method provided in this application is applied to virtual animation role-playing. FIG. 2 is a processing flowchart of a virtual prop display method applied to virtual animation role-playing according to an embodiment of this application. The following steps are specifically included:

Step 202: Determine preset pose information and virtual prop information.

In this embodiment, after a character appears in front of a lens and makes a classical action of an animation role, a virtual prop corresponding to the action may be displayed in a picture, to virtually play the animation role.

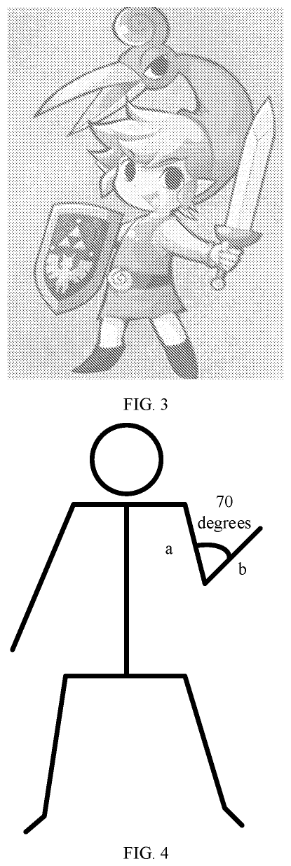

In a specific implementation of this application, that a preset pose is a pose of an animation soldier is used as an example. FIG. 3 is a schematic diagram of a preset pose according to an embodiment of this application. The preset pose information is created based on the pose of the animation soldier. FIG. 4 is a schematic diagram of a structure of a preset pose according to an embodiment of this application. Preset pose information of the animation soldier includes preset proportion information and preset angle information. The preset proportion information is that a length proportion of a skeleton a to a length of a skeleton b is 1:1 and a preset floating range is 0.2. The preset angle information is that an included angle between the skeleton a and the skeleton b is 70 degrees, and a preset floating range is five degrees. The skeleton a is a skeleton determined based on a left shoulder skeleton point and a left elbow skeleton point, and the skeleton b is a skeleton determined based on the left elbow skeleton point and a left wrist skeleton point.

It is determined that a virtual prop corresponding to the preset pose information of the animation soldier is a sword. The sword is a pre-created 3D prop model. 3D model information is obtained, and an anchor of the 3D prop model of the sword is determined. Skeleton point information is determined based on the preset pose information of the animation soldier, and the anchor of the 3D prop model is bound to a location that is on the skeleton including the left elbow skeleton point and the left wrist skeleton point and that is 5% close to the wrist and 30% above the skeleton. In other words, anchor information of the sword is preset. The anchor information of the sword and the 3D model information of the sword form the virtual prop information.

Step 204: Receive a to-be-processed video stream, and recognize a target video frame in the to-be-processed video stream.

In a specific implementation of this application, the foregoing example is still used. A to-be-processed video stream captured by a camera is received. In this embodiment, the target video frame is determined in the to-be-processed video stream based on a character recognition rule. Specifically, a video frame in the to-be-processed video stream is input into a pre-trained character image recognition model, so that a video frame that includes a character image in the video frame is determined as the target video frame.

Step 206: Parse the target video frame, to obtain a skeleton point information set.

In a specific implementation of this application, the foregoing example is still used. The target video frame is parsed, to obtain a plurality of skeleton points {a left shoulder, a left elbow, a left wrist, . . . } in the target video frame. A rectangular coordinate system is established in the target video frame, and coordinate information of the plurality of skeleton points obtained through parsing in the target video frame is determined based on the established rectangular coordinate system. For example, coordinates of the left shoulder are (2, 3), and coordinate information of all the skeleton points in the target video frame forms the skeleton point information set.

Step 208: Determine to-be-processed skeleton point information from the skeleton point information set based on the preset pose information, and convert the to-be-processed skeleton point information to obtain target skeleton point information.

In a specific implementation of this application, the foregoing example is still used. It is determined, in the skeleton point information set based on the preset pose information of the animation soldier, that a left elbow, a left wrist, and a left shoulder are to-be-processed skeleton points. It is determined that two-dimensional coordinate information of the to-be-processed skeleton points includes {left shoulder (15, 8), left elbow (18, 4), and left wrist (21, 8)}. A coordinate on a z axis of the two-dimensional to-be-processed skeleton point information is added by adding 0 to the two-dimensional to-be-processed skeleton point information, to obtain the three-dimensional target skeleton point information, including {left shoulder (15, 8, 0), left elbow (18, 4, 0), and left wrist (21, 8, 0)}.

Step 210: Determine whether the target skeleton point information falls within a preset pose information range.

In a specific implementation of this application, the foregoing example is still used. After a target skeleton point is determined, a target skeleton vector is obtained based on the target skeleton point. A skeleton vector from the left shoulder to the left elbow is obtained by subtracting coordinates of the left elbow skeleton point from coordinates of the left shoulder skeleton point, that is, (−3, 4, 0). Similarly, a skeleton vector from the left elbow to the left wrist is (−3, −4, 0). It is learned, through calculation based on the target skeleton vector, that a skeleton length from the left shoulder to the left elbow is 5, and a skeleton length from the left elbow to the left wrist is 5. Therefore, it is determined that proportion information of the skeleton a to the skeleton b is 1:1, and it is determined that proportion information in target skeleton information falls within the preset floating range. It is learned, through calculation based on the target skeleton vector, that a value of the included angle between the skeleton a and the skeleton b is 74 degrees, exceeds a preset angle by four degrees, and falls within the preset angle range, to determine that the target skeleton point information conforms to the preset pose information.

Step 212: When the target skeleton point information conforms to the preset pose information, obtain virtual prop information of a virtual prop corresponding to the preset pose information.

In a specific implementation of this application, the foregoing example is still used. After it is determined that the target skeleton point information obtained in the target video frame conforms to the preset pose information of the animation soldier, a virtual prop sword corresponding to the preset pose information of the animation soldier is obtained. Virtual prop information corresponding to the sword is determined from a preset virtual prop information table, and the virtual prop information includes virtual prop model information and virtual prop anchor information.

Step 214: Calculate, based on the virtual prop anchor information and the target skeleton point information, a virtual prop matrix existing when the virtual prop is displayed in the target video frame.

In a specific implementation of this application, the foregoing example is still used. It is determined, from the target skeleton point information, that three-dimensional coordinates of the left wrist and the left elbow are respectively B (21, 8, 0) and C (18, 4, 0). It is determined, through calculation based on the three-dimensional coordinates B and C and offset information A in the anchor information of the sword, that a matrix of a location that is on the skeleton including the left elbow skeleton point and the left wrist skeleton point and that is 5% close to the wrist is (B−C)*5%+C+A, and the matrix is used as an anchor matrix existing when the sword is displayed in the target video frame.

Step 216: Display the virtual prop based on the virtual prop matrix and the virtual prop model information in the virtual prop information.

In a specific implementation of this application, the foregoing example is still used. The sword is displayed in the target video frame based on the anchor matrix that is of the sword and that is obtained through calculation in step 214 and the virtual prop model information of the sword.

According to the virtual prop display method provided in this application, the to-be-processed video stream is received, and the target video frame in the to-be-processed video stream is recognized; the target video frame is parsed, to obtain the target skeleton point information; when the target skeleton point information conforms to the preset pose information, the virtual prop information of the virtual prop corresponding to the preset pose information is obtained; and the virtual prop is displayed in the target video frame based on the target skeleton point information and the virtual prop information. In this application, whether a pose in a video frame is consistent with a preset pose is determined based on the preset pose information. When the pose in the video frame is consistent with the preset pose, the virtual prop is displayed based on skeleton information in the video frame, to improve accuracy and a real degree of displaying the virtual prop and the pose, and bring a better visual effect to a user.

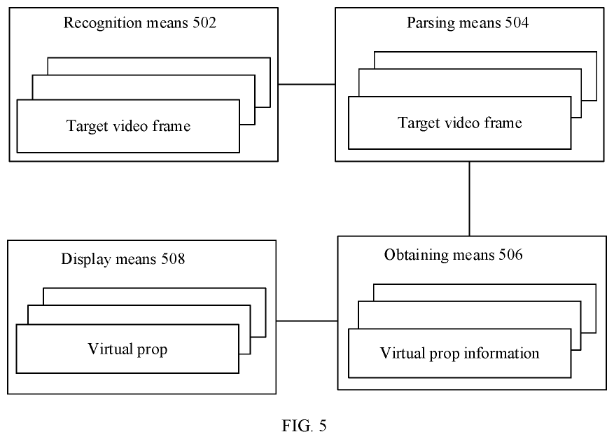

Corresponding to the method embodiment, this application further provides an embodiment of a virtual prop display apparatus. FIG. 5 is a schematic diagram of a structure of a virtual prop display apparatus according to an embodiment of this application. As shown in FIG. 5, the apparatus includes:
a recognition means 502, configured to: receive a to-be-processed video stream, and recognize a target video frame in the to-be-processed video stream;
a parsing means 504, configured to parse the target video frame, to obtain target skeleton point information;
an obtaining means 506, configured to: when the target skeleton point information conforms to preset pose information, obtain virtual prop information of a virtual prop corresponding to the preset pose information; and
a display means 508, configured to display the virtual prop in the target video frame based on the target skeleton point information and the virtual prop information.

In a specific implementation of this application, the apparatus further includes a determining means, configured to:
determine pose proportion information and/or pose angle information in preset pose information, and determine whether the target skeleton point information conforms to the pose proportion information and/or the pose angle information; and
if the target skeleton point information conforms to the pose proportion information and/or the pose angle information, determine that the target skeleton point information conforms to the preset pose information; or
if the target skeleton point information does not conform to the pose proportion information or the pose angle information, determine that the target skeleton point information does not conform to the preset pose information.

Optionally, the apparatus further includes a determining sub-means, configured to:
determine target skeleton vectors based on the target skeleton point information;
calculate skeleton proportion information and/or skeleton angle information between the target skeleton vectors; and
determine whether the skeleton proportion information conforms to the pose proportion information, and/or determine whether the skeleton angle information conforms to the pose angle information.

Optionally, the obtaining means 506 is further configured to:
determine the virtual prop corresponding to the preset pose information;
obtain a virtual prop information table; and
determine the virtual prop from the virtual prop information table, and obtain virtual prop information corresponding to the virtual prop.

Optionally, the display means 508 is further configured to:
calculate virtual prop anchor information of the virtual prop based on a virtual prop anchor of the virtual prop and the target skeleton point information; and
display the virtual prop in the target video frame based on the virtual prop information and the virtual prop anchor information.

Optionally, the display means 508 is further configured to:
calculate, based on the virtual prop anchor information in the virtual prop information and the target skeleton point information, a virtual prop matrix existing when the virtual prop is displayed in the target video frame.

Optionally, the apparatus further includes a preset pose means, configured to:
determine the pose angle information and/or the pose proportion information; and
generate the preset pose information based on the pose angle information and/or the pose proportion information.

Optionally, the apparatus further includes a preset virtual prop means, configured to:
obtain virtual prop model information of the virtual prop and the virtual prop anchor of the virtual prop;
define virtual prop anchor information of the virtual prop anchor between skeleton points based on the preset pose information corresponding to the virtual prop; and
generate the virtual prop information corresponding to the virtual prop based on the virtual prop model information and the virtual prop anchor information.

Optionally, the recognition means 502 is further configured to:
determine a preset recognition rule; and
recognize, as the target video frame based on the preset recognition rule, a video frame that conforms to the preset recognition rule in the to-be-processed video stream.

Optionally, the parsing means 504 is further configured to:
parse the target video frame, to obtain a skeleton point information set;
determine to-be-processed skeleton point information from the skeleton point information set based on the preset pose information; and
convert the to-be-processed skeleton point information, to obtain the target skeleton point information.

Optionally, the apparatus further includes an execution means, configured to:
if the target skeleton point information does not conform to the preset pose information, continue to perform the step of recognizing a target video frame in the to-be-processed video stream.

According to the virtual prop display apparatus in this application, the recognition means receives the to-be-processed video stream, and recognizes the target video frame in the to-be-processed video stream; the parsing means parses the target video frame, to obtain the target skeleton point information; when the target skeleton point information conforms to the preset pose information, the obtaining means obtains the virtual prop information of the virtual prop corresponding to the preset pose information; and the display means displays the virtual prop in the target video frame based on the target skeleton point information and the virtual prop information. Whether a pose in a video frame is consistent with a preset pose is determined based on the preset pose information. When the pose in the video frame is consistent with the preset pose, the virtual prop is displayed based on skeleton information in the video frame, to improve accuracy and a real degree of displaying the virtual prop and the pose, and bring a better visual effect to a user.

The foregoing describes a schematic solution of the virtual prop display apparatus in the embodiments. It should be noted that the technical solution of the virtual prop display apparatus and the technical solution of the virtual prop display method belong to the same concept. For details not described in the technical solution of the virtual prop display apparatus, refer to the descriptions of the technical solution of the virtual prop display method.

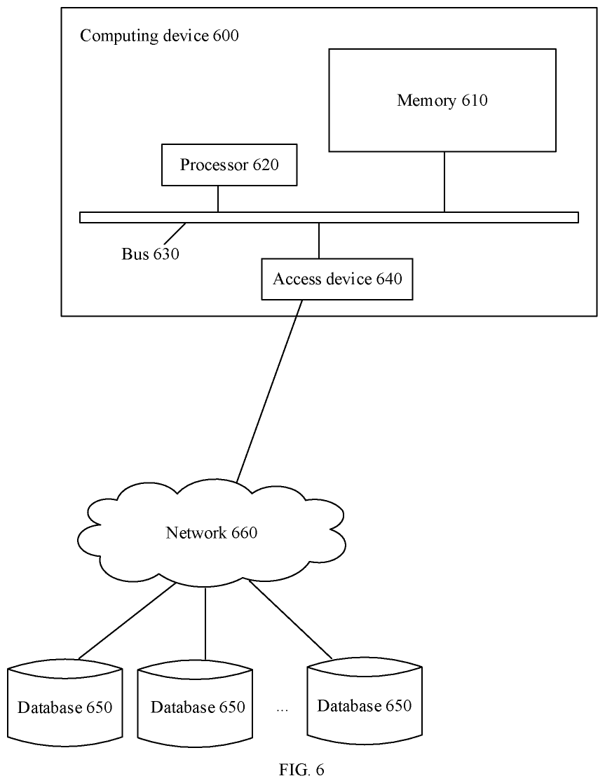

FIG. 6 is a block diagram of a structure of a computing device 600 according to an embodiment of this application. Components of the computing device 600 include but are not limited to a memory 610 and a processor 620. The processor 620 is connected to the memory 610 through a bus 630, and a database 650 is configured to store data.

The computing device 600 further includes an access device 640. The access device 640 enables the computing device 600 to perform communication through one or more networks 660. Examples of these networks include a public switched telephone network (PSTN), a local area network (LAN), a wide area network (WAN), a private area network (PAN), or a combination of communication networks such as the Internet. The access device 640 may include one or more of any type of wired or wireless network interfaces (for example, a network interface card (NIC)) such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of this application, the foregoing components of the computing device 600 and other components not shown in FIG. 6 may be connected to each other, for example, through a bus. It should be understood that the block diagram of the structure of the computing device shown in FIG. 6 is merely an example, and is not intended to limit the scope of this application. A person skilled in the art can add or replace other components based on a requirement.

The computing device 600 may be any type of stationary or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smartwatch or smart glasses), another type of mobile device, or a stationary computing device, for example, a desktop computer or a PC. The computing device 600 may alternatively be a mobile or stationary server.

The processor 620 implements steps of the virtual prop display method when executing computer instructions.

The foregoing describes a schematic solution of the computing device in the embodiments. It should be noted that the technical solution of the computing device and the technical solution of the virtual prop display method belong to a same concept. For details not described in detail in the technical solution of the computing device, refer to the descriptions of the technical solution of the virtual prop display method.

An embodiment of this application further provides a computer-readable storage medium. The computer-readable storage medium stores computer instructions, and when the computer instructions are executed by a processor, steps of the virtual prop display method are implemented.

The foregoing describes a schematic solution of the computer-readable storage medium in the embodiments. It should be noted that the technical solution of the storage medium and the technical solution of the virtual prop display method belong to a same concept. For details not described in detail in the technical solution of the storage medium, refer to the descriptions of the technical solution of the virtual prop display method.

An embodiment of this application further provides a computer program. When the computer program is executed on a computer, the computer is enabled to perform steps of the virtual prop display method.

The foregoing describes a schematic solution of the computer program in the embodiments. It should be noted that the technical solution of the computer program and the technical solution of the virtual prop display method belong to a same concept. For details not described in detail in the technical solution of the computer program, refer to the descriptions of the technical solution of the virtual prop display method.

The foregoing describes specific embodiments of this application. Other embodiments fall within the scope of the appended claims. In some cases, actions or steps recorded in the claims may be performed in a sequence different from that in the embodiments and desired results may still be achieved. In addition, processes described in the accompanying drawings do not necessarily require a specific order or a sequential order shown to achieve the desired results. In some implementations, multitasking and parallel processing are also possible or may be advantageous.

The computer instructions include computer program code, and the computer program code may be in a source code form, an object code form, an executable file form, an intermediate form, or the like. The computer-readable medium may include: any entity or apparatus capable of carrying the computer program code, a recording medium, a USB flash drive, a removable hard disk, a magnetic disk, a compact disc, a computer memory, a read-only memory (ROM), a random access memory (RAM), an electrical carrier signal, a telecommunication signal, a software distribution medium, or the like. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include an electrical carrier signal or a telecommunication signal.

It should be noted that, for ease of description, the foregoing method embodiments are described as a combination of a series of actions. However, a person skilled in the art should understand that this application is not limited to the described action sequence, because according to this application, some steps may be performed in another order or simultaneously. In addition, a person skilled in the art should also be aware that the embodiments described in this specification are all preferred embodiments, and used actions and means are not necessarily mandatory to this application.

In the foregoing embodiments, the descriptions of various embodiments have respective focuses. For a part that is not described in detail in an embodiment, reference may be made to related descriptions in other embodiments.

The preferred embodiments of this application disclosed above are merely intended to help describe this application. In the optional embodiments, not all details are described in detail, and the present invention is not limited to only the specific implementations. Clearly, many modifications and variations may be made based on the content of this application. In this application, these embodiments are selected and specifically described to better explain the principle and actual application of this application, so that a person skilled in the art can well understand and use this application. This application is only subject to the claims and a full scope and equivalents thereof.

1. A method of displaying virtual props, comprising:
receiving a to-be-processed video stream, and recognizing a target video frame in the to-be-processed video stream;
generating target skeleton point information based on parsing the target video frame;
in response to determining that the target skeleton point information conforms to preset pose information, obtaining virtual prop information of a virtual prop corresponding to the preset pose information, wherein the preset pose information comprises at least one of pose proportion information or pose angle information, and the preset pose information indicates a preset pose; and
displaying the virtual prop in the target video frame based on the target skeleton point information and the virtual prop information.

2. The method according to claim 1, wherein the method further comprises:
calculating at least one of a target pose proportion or a target pose angle based on the target skeleton point information; and
determining whether the target skeleton point information conforms to the preset pose information based on the at least one of the target pose proportion or the target pose angle.

3. The method according to claim 1, further comprising:
determining target skeleton vectors based on the target skeleton point information;
calculating at least one of a target pose proportion or a target pose angle based on the target skeleton vectors;
determining whether the target pose proportion conforms to the pose proportion information; and
determining whether the target pose angle conforms to the pose angle information.

4. The method according to claim 1, wherein the obtaining virtual prop information of a virtual prop corresponding to the preset pose information comprises:
determining the virtual prop corresponding to the preset pose information based on a virtual prop information table, wherein the virtual prop information table comprises data indicative of virtual props and corresponding preset pose information; and
obtaining the virtual prop information corresponding to the virtual prop.

5. The method according to claim 1, wherein the displaying the virtual prop in the target video frame based on the target skeleton point information and the virtual prop information comprises:
determining virtual prop anchor information of the virtual prop based on a preset virtual prop anchor of the virtual prop and the target skeleton point information, wherein the preset virtual prop anchor of the virtual prop indicates a center point of the virtual prop in the preset pose, wherein the virtual prop information comprises information indicative of the preset virtual prop anchor, and wherein the virtual prop anchor information of the virtual prop comprise skeleton point location information and offset information for display of a virtual prop anchor of the virtual prop in the target video frame; and
displaying the virtual prop in the target video frame based on the virtual prop information and the virtual prop anchor information.

6. The according to claim 5, further comprising:
calculating, based on the virtual prop anchor information and the target skeleton point information, a virtual prop matrix of displaying the virtual prop in the target video frame, wherein the virtual prop matrix indicates coordinates of displaying the virtual prop in the target video frame.

7. The method according to claim 1, wherein before the receiving a to-be-processed video stream, the method further comprises:
determining the at least one of the pose angle information or the pose proportion information; and
generating the preset pose information based on the at least one of the pose angle information or the pose proportion information.

8. The method according to claim 1, wherein the method further comprises pre-generating the virtual prop information of the virtual prop corresponding to the preset pose information, and wherein the pre-generating the virtual prop information of the virtual prop corresponding to the preset pose information comprises:
obtaining virtual prop model information of the virtual prop and a virtual prop anchor of the virtual prop;
configuring virtual prop anchor information of the virtual prop anchor relative to skeleton points based on the preset pose information; and
generating the virtual prop information corresponding to the virtual prop based on the virtual prop model information and the virtual prop anchor information.

9. The method according to claim 1, wherein the recognizing a target video frame in the to-be-processed video stream comprises:
determining a preset recognition rule; and
recognizing the target video frame based on the preset recognition rule, wherein the target video frame is a video frame in the to-be-processed video stream that conforms to the preset recognition rule.

10. The method according to claim 1, wherein the generating target skeleton point information based on parsing the target video frame comprises:
parsing the target video frame to obtain a set of skeleton point information, wherein the set of skeleton point information comprises information indicative of locations of skeleton points in the target video frame;
determining to-be-processed skeleton point information among the set of skeleton point information based on the preset pose information; and
generating the target skeleton point information by converting the to-be-processed skeleton point information into three-dimensional skeleton point information.

11. The method according to claim 1, wherein the method further comprises:
in response to determining that the target skeleton point information does not conform to the preset pose information, iterating the recognizing a target video frame in the to-be-processed video stream.

12. (canceled)

13. A computing device, comprising a memory, a processor, and
computer instructions stored in the memory and executable by the processor, wherein the computer instructions, when executed by the processor, cause the processor to implement operations comprising:
receiving a to-be-processed video stream, and recognizing a target video frame in the to-be-processed video stream;
generating target skeleton point information based on parsing the target video frame;
in response to determining that the target skeleton point information conforms to preset pose information, obtaining virtual prop information of a virtual prop corresponding to the preset pose information, wherein the preset pose information comprises at least one of pose proportion information or pose angle information, and the preset pose information indicates a preset pose; and
displaying the virtual prop in the target video frame based on the target skeleton point information and the virtual prop information.

14. A non-transitory computer-readable storage medium, wherein the computer-readable storage medium stores computer instructions, and the computer instructions, when executed by a processor, cause the processor to implement operations comprising:
receiving a to-be-processed video stream, and recognizing a target video frame in the to-be-processed video stream;
generating target skeleton point information based on parsing the target video frame;
in response to determining that the target skeleton point information conforms to preset pose information, obtaining virtual prop information of a virtual prop corresponding to the preset pose information, wherein the preset pose information comprises at least one of pose proportion information or pose angle information, and the preset pose information indicates a preset pose; and
displaying the virtual prop in the target video frame based on the target skeleton point information and the virtual prop information.

15. (canceled)

16. The computing device according to claim 13, the operations further comprising:
determining target skeleton vectors based on the target skeleton point information;
calculating at least one of a target pose proportion or a target pose angle based on skeleton proportion information or skeleton angle information between the target skeleton vectors;
determining whether the target pose skeleton proportion information conforms to the pose proportion information; and
determining whether the target pose skeleton angle information conforms to the pose angle information.

17. The computing device according to claim 13, wherein the obtaining virtual prop information of a virtual prop corresponding to the preset pose information further comprises:
determining the virtual prop corresponding to the preset pose information based on a virtual prop information table, wherein the virtual prop information table comprises data indicative of virtual props and corresponding preset pose information; and
obtaining the virtual prop information corresponding to the virtual prop.

18. The computing device according to claim 13, wherein the displaying the virtual prop in the target video frame based on the target skeleton point information and the virtual prop information comprises:
determining virtual prop anchor information of the virtual prop based on a preset virtual prop anchor of the virtual prop and the target skeleton point information, wherein the preset virtual prop anchor of the virtual prop indicates a center point of the virtual prop in the preset pose, wherein the virtual prop information comprises information indicative of the preset virtual prop anchor, and wherein the virtual prop anchor information of the virtual prop comprise skeleton point location information and offset information for display of a virtual prop anchor of the virtual prop in the target video frame; and
displaying the virtual prop in the target video frame based on the virtual prop information and the virtual prop anchor information.

19. The computing device according to claim 18, the operations further comprising:
calculating, based on the virtual prop anchor information and the target skeleton point information, a virtual prop matrix of displaying the virtual prop in the target video frame, wherein the virtual prop matrix indicates coordinates of displaying the virtual prop in the target video frame.

20. The computing device according to claim 13, wherein the generating target skeleton point information based on parsing the target video frame comprises:
parsing the target video frame to obtain a set of skeleton point information, wherein the set of skeleton point information comprises information indicative of locations of skeleton points in the target video frame;
determining to-be-processed skeleton point information among the set of skeleton point information based on the preset pose information; and
generating the target skeleton point information by converting the to-be-processed skeleton point information into three-dimensional skeleton point information.

21. The non-transitory computer-readable storage medium according to claim 14, wherein the displaying the virtual prop in the target video frame based on the target skeleton point information and the virtual prop information comprises:
determining virtual prop anchor information of the virtual prop based on a preset virtual prop anchor of the virtual prop and the target skeleton point information, wherein the preset virtual prop anchor of the virtual prop indicates a center point of the virtual prop in the preset pose, wherein the virtual prop information comprises information indicative of the preset virtual prop anchor, and wherein the virtual prop anchor information of the virtual prop comprise skeleton point location information and offset information for display of a virtual prop anchor of the virtual prop in the target video frame; and
displaying the virtual prop in the target video frame based on the virtual prop information and the virtual prop anchor information.

22. The non-transitory computer-readable storage medium according to claim 14, wherein the generating target skeleton point information based on parsing the target video frame comprises:
parsing the target video frame to obtain a set of skeleton point information, wherein the set of skeleton point information comprises information indicative of locations of skeleton points in the target video frame;
determining to-be-processed skeleton point information among the set of skeleton point information based on the preset pose information; and
generating the target skeleton point information by converting the to-be-processed skeleton point information into three-dimensional skeleton point information.
